(19) United States
(12) Patent Application Publication
(10) Pub. No.: US 2009/0119144 A1
(43) Pub. Date: May 7, 2009

(54) METHOD, SYSTEM AND PROGRAM PRODUCT FOR OPTIMAL PROJECT SELECTION AND TRADEOFFS

(75) Inventor: Praduemn K. Goyal, Holmdel, NJ (US)

Correspondence Address: SILVY ANNA MURPHY, 100 TURNBERRY LANE, CARY, NC, 27518, US

(73) Assignee: INTERNATIONAL BUSINESS MACHINES CORPORATION, Armonk, NY (US)

(21) Appl. No.: 11/934,516

(22) Filed: Nov. 2, 2007

(51) Int. Cl. G06Q 10/00; G06F 17/40; G06F 19/00

(52) U.S. Cl. 705/8

(57) ABSTRACT

A method, system and program product for determining an optimal expected business value. The method includes inputting, into a tool, one or more projects, estimating business value, establishing impacts for resource and/or capacity demands and constraints, project dependencies, business value and risks, identifying projects to tradeoff when new projects arise and when change requests for projects emerge and determining, using the tool, an optimal project portfolio using results of the identifying step that can be utilized under any resource and capacity demands and constraints, project dependencies, business value, and risks established and based on identification of any tradeoff projects, wherein the optimal project portfolio provides an optimal expected business value for the business. The method further includes identifying, deselecting and trading off suboptimal projects in the optimal candidate project portfolio to tradeoff either when a new candidate project is inputted or when a change request arrives.

### FIELD OF THE INVENTION

The present invention relates to computer systems and software, and more specifically to an automated technique for optimal project selection and tradeoffs in a business for achieving an optimal expected business value.

### BACKGROUND OF THE INVENTION

In today's business environment, an organization and/or business has finite resources available for developing and/or maintaining an information technology solution or infrastructure for operating a business. Accordingly, a reasonably accurate and up-front estimate of the costs associated with constructing and evaluating various business initiatives and/or updating an existing business plans can provide an organization and/or business with a competitive advantage in the marketplace and accelerate proposal, development and approval process for new business initiatives and can also prevent costly price overruns and implementation delays. As such, there is a need for an efficient way to construct and/or evaluate various initiatives being considered by a business.

### SUMMARY OF THE INVENTION

In a first aspect of the invention, there is provided a method for determining an optimal expected business value. The method includes inputting, into a tool, one or more candidate projects for a business, assessing impacts of any resource demands, any resource constraints, any capacity demands, any capacity constraints established, including assessing any project dependencies, business value and any risks associated with the one or more candidate projects inputted, estimating an expected business value for the one or more candidate projects inputted based on the business value assessed and any risks assessed for the business, the expected business value including a probability of achieving the business and determining, using the tool, an optimal candidate project portfolio using results of the assessing step that can be utilized under any resource demands, the resource constraints, any capacity demands, any capacity constraints established, any project dependencies and any risks assessed and based on the expected business value estimated for the business, wherein the optimal candidate project portfolio provides an optimal expected business value for the business. In an embodiment, the inputting step further includes providing the tool for inputting the one or more candidate projects for the business, wherein the tool includes a portfolio optimization-tradeoff engine. The method further includes identifying suboptimal projects of the one or more candidate projects in the optimal candidate project portfolio to tradeoff either when a new candidate project is inputted or when a change request arrives, deselecting any of the suboptimal projects identified in the optimal candidate project portfolio, identifying tradeoff candidates to tradeoff for increasing the expected business value estimated and trading any of the tradeoff candidates identified as necessary. In an embodiment, the determining step further includes selecting projects from the one or more candidate projects for the optimal candidate project portfolio that can be utilized under any resource demands, resource constraints, any capacity demands, any capacity constraints established, any project dependencies and any risks assessed, such that, a probability of achieving the optimal expected business value for the business is optimized. In an embodiment, the determining step further includes constructing a first candidate project portfolio included of the one or more candidate projects inputted for the business, changing combinations of the one or more candidate projects in the first candidate project portfolio constructed and determining a respective expected business value for the first candidate project portfolio for the business. In an embodiment, the changing step further includes adding a candidate project to the one or more candidate projects in the first candidate project portfolio constructed to create a second candidate project portfolio, assessing impacts of respective resource demands, respective resource constraints, respective capacity demands, respective capacity constraints and assessing respective project dependencies, respective business values and respective risks for the second candidate project portfolio and ascertaining a respective expected business value for the second candidate project portfolio based on the respective business values assessed and based on the respective risks assessed for the second candidate project portfolio, including a respective probability of achieving the business utilizing the second candidate project portfolio, wherein the respective expected business value for the second candidate project portfolio is optimized. In an embodiment, the changing step further includes excluding a candidate project of the one or more candidate projects in a candidate project portfolio constructed to create a different candidate project portfolio, assessing impacts of different resource demands, different resource constraints, different capacity demands, different capacity constraints and assessing different project dependencies, respective business values and respective risks for the second candidate project portfolio and ascertaining a respective expected business value for the different candidate project portfolio based on the different business values assessed and based on the different risks assessed for the different candidate project portfolio, including a respective probability of achieving the business utilizing the different candidate project portfolio, wherein the respective expected business value for the different candidate project portfolio is optimized. The method further includes repeating changing combinations of a respective optimal candidate project portfolio determined for the business to achieve a respective optimal expected business value for the business.

In another aspect of the invention, there is provided a system for determining an optimal expected business value. The system includes a user interface configured to receive input of one or more candidate projects for a business, a processor configured to execute processing functions and to coordinate a plurality of activities and events for determining an optimal expected business value for the one or more candidate projects inputted for the business, a memory module having installed thereon a tool configured to determine an optimal candidate project portfolio that provides an optimal expected business value for the business. The tool further includes a resource and capacity module configured to identify any resource demands, any resource constraints, any capacity demands and any capacity constraints for the one or more candidate projects inputted, a risk assessment module configured to assess any risks associated with the one or more candidate projects inputted, a business valuation module configured to ascertain an estimated business value and an expected business value for the one or more candidate projects inputted, the expected business value including any risks assessed for the one or more candidate projects inputted, a portfolio module configured to construct an optimal candidate project portfolio using the one or more candidate projects inputted for the business based on any resource demands identified, any resource constraints identified, any capacity demands identified, any capacity constraints identified and any risks associated with the one or more candidate projects inputted, a tradeoff module configured to identify candidate projects to tradeoff when new candidate projects arise and when change requests for the one or more candidate projects inputted emerge for determining the optimal candidate project portfolio and a communications module configured to interconnect each of the user interface, the processor, the memory module and the tool for enabling data exchange. In an embodiment, the tool further includes an impact module configured to evaluate impact of any resource demands identified, any resource constraints identified, any capacity demands identified, any capacity constraints identified and a dependencies module configured to estimate dependencies between the one or more candidate projects inputted. The system further includes a storage module configured to store a respective optimal candidate project portfolio constructed and a respective expected business value computed for the respective optimal candidate project portfolio in a repository and a retrieval module configured to retrieve a respective optimal candidate project portfolio constructed and a respective expected business value computed for the respective optimal candidate project portfolio in the repository. The tool is further configured to construct a first candidate project portfolio that includes the one or more candidate projects for the business and is configured to allow combination changes to the one or more candidate projects in the first candidate project portfolio constructed in order to determine a respective expected business value for the first candidate project portfolio for the business. In an embodiment, the tool is further configured to add a candidate project to the one or more candidate projects to create a second candidate project portfolio, to establish resource constraints, capacity constraints and risks for the second candidate project portfolio, to ascertain a respective expected business value for the second candidate project portfolio and to compute a probability of achieving the business utilizing the second candidate project portfolio, wherein the respective expected business value for the second candidate project portfolio is optimized. In an embodiment, the tool is further configured to exclude a candidate project of the one or more candidate projects to create a different candidate project portfolio, to establish resource constraints, capacity constraints and risks for the different candidate project portfolio, to ascertain a respective expected business value for the different candidate project portfolio and to compute a probability of achieving the business utilizing the different candidate project portfolio, wherein the respective expected business value for the different candidate project portfolio is optimized.

In yet another aspect of the invention, there is provided a computer program product for determining an optimal expected business value. The computer program product includes a computer readable medium, first program instructions to input one or more candidate projects for a business, the first program instructions including instructions to input any resource demands, any resource constraints, any capacity demands, any capacity constraints, any project dependencies and any risks associated with the one or more candidate projects, second program instructions to ascertain an estimated business value for the one or more candidate projects inputted, the second program instructions including instructions to compute an expected business value using the estimated business value ascertained, the expected business value being based on a probability of achieving the business given the resource demands, any resource constraints, any capacity demands, any capacity constraints, any risks and any project dependencies associated with the one or more candidate projects inputted, third program instructions to determine an optimal candidate project portfolio that optimizes the expected business value computed for the business that can be utilized under any resource demands, any resource constraints, any capacity demands, any capacity constraints, any risks and any project dependencies. The computer program product further includes fourth program instructions to identify optimal projects to tradeoff when new candidate projects arise and when change requests for the one or more candidate projects inputted emerge in order to determine the optimal candidate project portfolio. In an embodiment, the first program instructions include instructions to construct a first candidate project portfolio included of the one or more candidate projects for the business, to change combinations of the one or more candidate projects in the first candidate project portfolio constructed and to determine a respective expected business value for the first candidate project portfolio constructed for the business. In an embodiment, the second program instructions include instructions to add a candidate project to the one or more candidate projects to create a second candidate project portfolio, to establish any other resource demands, any other resource constraints, any other capacity demands, any other capacity constraints, any other risks and any other dependencies for the second candidate project portfolio, to ascertain a respective expected business value for the second candidate project portfolio using a probability of achieving the business utilizing the second candidate project portfolio, wherein the respective expected business value for the second candidate project portfolio is optimized. In an embodiment, the third program instructions include instructions to exclude a candidate project of the one or more candidate projects to create a different candidate project portfolio, to establish respective resource demands, respective resource constraints, respective capacity demands, respective capacity constraints, respective risks and respective dependencies for the different candidate project portfolio, to ascertain a respective expected business value for the different candidate project portfolio using a probability of achieving the business utilizing the different candidate project portfolio, wherein the respective expected business value for the different candidate project portfolio is optimized. In an embodiment, the fourth program instructions include instructions to identify suboptimal projects of the one or more candidate projects in the optimal candidate project portfolio to tradeoff either when the new candidate project is inputted or when the change request arrives, the fourth program instructions including instructions to deselect any of the suboptimal projects identified, identifying tradeoff candidates to tradeoff for increasing the expected business value estimated and trading any of the tradeoff candidates identified as necessary. In an embodiment, each of the first, second, third and fourth program instructions are recorded on the computer readable medium.

Further, in yet another aspect of the invention, there is provided a process for deploying computing infrastructure comprising integrating computer-readable code into a computing system, wherein the code in combination with the computing system is capable of performing a process for determining an optimal expected business value for a business. The process includes inputting one or more candidate projects for a business, including any resource demands, any resource constraints, any capacity demands, any capacity constraints, any risks and any project dependencies associated with the one or more candidate projects inputted, ascertaining an estimated business value and an expected business value based on a probability of achieving the business given any resource demands, any resource constraints, any capacity demands, any capacity constraints, any risks and any project dependencies associated with the one or more candidate projects inputted, determining an optimal candidate project portfolio that can be utilized under any resource demands, any resource constraints, any capacity demands, any capacity constraints and can provide an optimal expected business value for the business and identifying optimal projects to tradeoff when new candidate projects arise and when change requests for the one or more candidate projects inputted emerge for determining the optimal candidate project portfolio for the business. The process further includes identifying suboptimal projects of the one or more candidate projects in the optimal candidate project portfolio to tradeoff either when a new candidate project is inputted or when a change request arrives, deselecting any of the suboptimal projects identified in the optimal candidate project portfolio, identifying tradeoff candidates to tradeoff for increasing the expected business value estimated and trading any of the tradeoff candidates identified as necessary. The process further includes constructing a first candidate project portfolio included of the one or more candidate projects for the business, changing combinations of the one or more candidate projects in the first candidate project portfolio constructed and determining a respective optimal expected business value for the first candidate project portfolio for the business. In an embodiment, the changing step further includes adding a candidate project to the one or more candidate projects in the first candidate project portfolio constructed to create a second candidate project portfolio, establishing resource constraints, capacity constraints and risks for the second candidate project portfolio, ascertaining a respective expected business value for the second candidate project portfolio and computing a probability of achieving the business utilizing the second candidate project portfolio, wherein the respective expected business value for the second candidate project portfolio is optimized. In an embodiment, the changing step includes excluding a candidate project of the one or more candidate projects in a candidate project portfolio constructed to create a different candidate project portfolio, establishing resource constraints, capacity constraints and risks for the different candidate project portfolio, ascertaining a respective expected business value for the different candidate project portfolio and ascertaining a respective expected business value for the different candidate project portfolio based on a probability of achieving the business utilizing the different candidate project portfolio and based on the risks established, wherein the respective expected business value for the different candidate project portfolio is optimized.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts a flowchart outlining the steps performed by a project optimization and tradeoff engine or program tool or code for determining an optimal expected business value for a business, in accordance with an embodiment of the present invention.

FIG. 2 is a schematic block system diagram illustrating an embodiment of a system having deployed thereon a project optimization and tradeoff engine or program tool or code for determining an optimal expected business value for a business, in accordance with an embodiment of the present invention.

FIG. 3 is a schematic block system diagram of a project portfolio management infrastructure having an optimization and tradeoff engine or program tool or code for determining an optimal expected business value for a business, in accordance with an embodiment of the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. Modules may also be implemented in software for execution by various types of processors. An identified module or component of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Further, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, over disparate memory devices, and may exist, at least partially, merely as electronic signals on a system or network. Furthermore, modules may also be implemented as a combination of software and one or more hardware devices. For instance, a module may be embodied in the combination of a software executable code stored on a memory device. In a further example, a module may be the combination of a processor that operates on a set of operational data. Still further, a module may be implemented in the combination of an electronic signal communicated via transmission circuitry.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

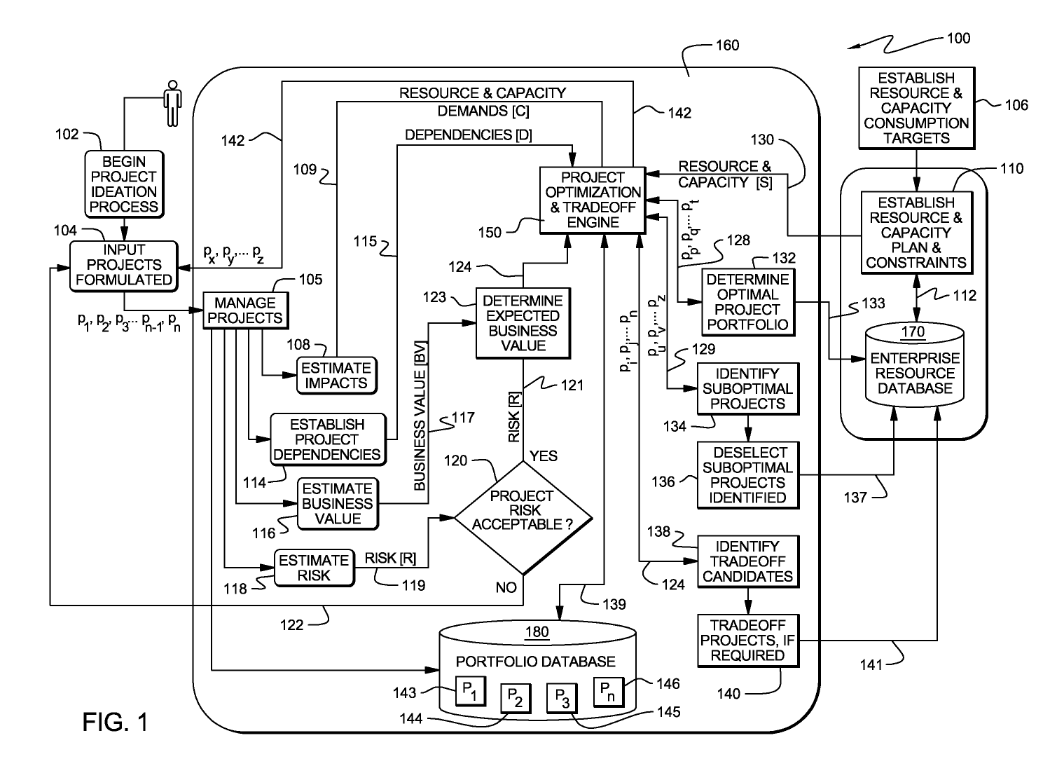

In one embodiment, as shown in FIG. 1, the invention provides a method 100 for optimal project selection and tradeoffs for optimizing expected business value for a business. In particular, the invention provides a method of identifying using a project optimization and tradeoff engine or program tool or code configured to optimize project selection and tradeoffs for optimizing expected business value for a business. The method includes inputting, into a tool, one or more candidate projects for a business, assessing impacts of any resource demands, any resource constraints, any capacity demands, any capacity constraints established, including assessing any project dependencies, business value and any risks associated with the one or more candidate projects inputted, estimating an expected business value for the one or more candidate projects inputted based on the business value assessed and any risks assessed for the business, the expected business value including a probability of achieving the business and determining, using the tool, an optimal candidate project portfolio using results of the assessing step that can be utilized under any resource demands, the resource constraints, any capacity demands, any capacity constraints established, any project dependencies and any risks assessed and based on the expected business value estimated for the business, wherein the optimal candidate project portfolio provides an optimal expected business value for the business. In an embodiment, the inputting step further includes providing the tool for inputting the one or more candidate projects for the business, wherein the tool includes a portfolio optimization-tradeoff engine. The method further includes identifying suboptimal projects of the one or more candidate projects in the optimal candidate project portfolio to tradeoff either when a new candidate project is inputted or when a change request arrives, deselecting any of the suboptimal projects identified in the optimal candidate project portfolio, identifying tradeoff candidates to tradeoff for increasing the expected business value estimated and trading any of the tradeoff candidates identified as necessary. In an embodiment, the determining step further includes selecting projects from the one or more candidate projects for the optimal candidate project portfolio that can be utilized under any resource demands, resource constraints, any capacity demands, any capacity constraints established, any project dependencies and any risks assessed, such that, a probability of achieving the optimal expected business value for the business is optimized. In an embodiment, the determining step further includes constructing a first candidate project portfolio included of the one or more candidate projects inputted for the business, changing combinations of the one or more candidate projects in the first candidate project portfolio constructed and determining a respective expected business value for the first candidate project portfolio for the business. In an embodiment, the changing step further includes adding a candidate project to the one or more candidate projects in the first candidate project portfolio constructed to create a second candidate project portfolio, assessing impacts of respective resource demands, respective resource constraints, respective capacity demands, respective capacity constraints and assessing respective project dependencies, respective business values and respective risks for the second candidate project portfolio and ascertaining a respective expected business value for the second candidate project portfolio based on the respective business values assessed and based on the respective risks assessed for the second candidate project portfolio, including a respective probability of achieving the business utilizing the second candidate project portfolio, wherein the respective expected business value for the second candidate project portfolio is optimized. In an embodiment, the changing step further includes excluding a candidate project of the one or more candidate projects in a candidate project portfolio constructed to create a different candidate project portfolio, assessing impacts of different resource demands, different resource constraints, different capacity demands, different capacity constraints and assessing different project dependencies, respective business values and respective risks for the second candidate project portfolio and ascertaining a respective expected business value for the different candidate project portfolio based on the different business values assessed and based on the different risks assessed for the different candidate project portfolio, including a respective probability of achieving the business utilizing the different candidate project portfolio, wherein the respective expected business value for the different candidate project portfolio is optimized. The method further includes repeating changing combinations of a respective optimal candidate project portfolio determined for the business to achieve a respective optimal expected business value for the business.

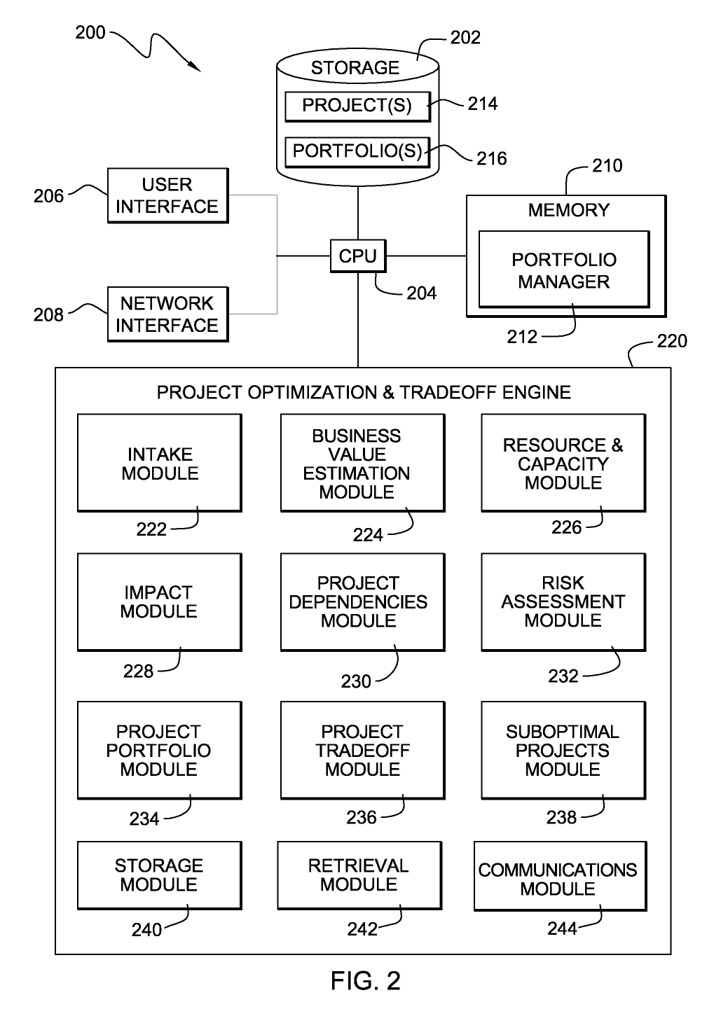

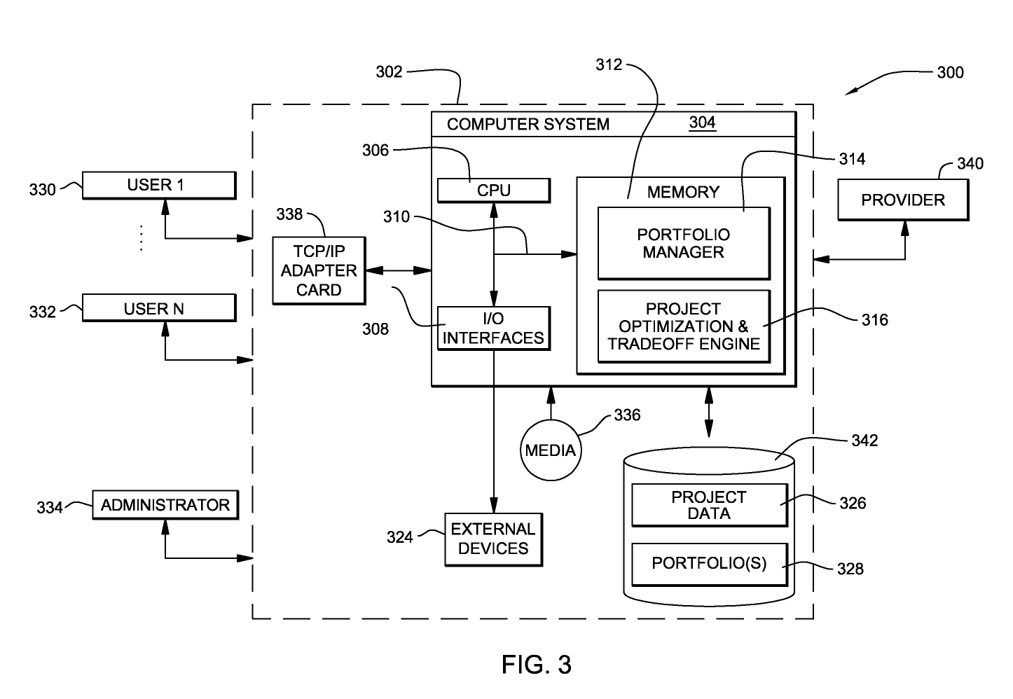

Turning to FIG. 1, in an embodiment, the project optimization and tradeoff engine or tool 150 runs on a computer system, such as, a server 160, in particular, a server or system 160 that has a project portfolio management software deployed thereon that is configured to manage project portfolios, as discussed herein below with respect to FIGS. 2 and 3. In an embodiment, the project portfolio management software comprises Rational Portfolio Manager (RPM), which is commercially available from International Business Machines Corporation (IBM). Turning to FIG. 1, the method 100 begins with the project ideation process in step 102, where one or more projects are generated by one or more business personnel or business team members during the project ideation process. Accordingly, the one or more candidate projects (or simply referred to as “projects”) generated, such as, p₁, p₂, p₃ through pₙ are formulated and inputted in step 104 into a project portfolio management system 160 that has deployed thereon a project optimization and tradeoff engine 150 that utilizes the project portfolio management system 160 to determine an optimal project portfolio that optimizes expected business value. In particular, the project optimization and tradeoff engine 150 manages in step 105 the projects inputted into the project portfolio management system 160 by estimating impacts (in step 108) of the resource and capacity demands and constraints established, by establishing project dependencies between the various projects in step 114, by estimating business value in step 116, by estimating risks associated with the one or more formulated projects, in step 118 and by determining expected business value in step 122 by using (indicated by arrow 117) the estimated business value calculated in step 116 and by using (indicated by arrow 121) the estimated risk assessment in steps 118 through 120. Further, in an embodiment, the project optimization and tradeoff engine 150 deployed on the portfolio management system 160 is configured to determine an optimal project portfolio (in step 132) that maximizes or optimizes the expected business value calculated or determined (in step 122) by the project portfolio management system 160, utilizing the projects data inputted into the project optimization and tradeoff engine 150 and based on identifying suboptimal projects (step 134) and/or identifying tradeoff candidates (step 138), that is, identifying projects to tradeoff when new projects arise and/or when change requests arise, as will be discussed herein below. Turning to the right side of FIG. 1, the project portfolio management system 160 establishes, in step 106, resource and capacity consumption targets and establishes in step 110 resource and capacity consumption plans and constraints for the business. In an embodiment, the resource and capacity data from steps 106 and 110 are stored (indicated by double-sided arrow 112) in a database, such as, an Enterprise Resource Database 170. In an embodiment, the resources in the business are organized in functional divisions (domains). These functional divisions could be business functions or systems development and maintenance factories. The Enterprise Resource Database 170 maintains an inventory of human and system resources, employed by the business, along with the domains and roles. Further, human resources are ascribed with skills and competencies in the database. The resource database is further augmented with projected resource additions and attritions that are projected or planned for the future and is kept current as resources enter or leave the enterprise and when the growth/attrition plans and projections are adjusted. This constitutes the total supply. The database is also initialized with current committed capacity and resource consumption by committed in-plan projects and is calculated as sum of all committed project demands (consumed capacity). The available resource and capacity is then the difference of total supply and consumed capacity. The project portfolio management system uses the available capacity to evaluate and assign resources and capacity to new projects being considered. Once an optimal portfolio is identified or determined (in step 132) by the portfolio optimization and tradeoff engine 150, required capacity and resources are reserved in the Enterprise Resource Database 170. The available capacity and reservations are updated as the portfolio optimization and tradeoff engine 150 selects additional projects or deselects projects that are traded off, discussed further herein below. As shown in FIG. 1, the resource and capacity data from steps 106 and 110 are inputted (indicated by arrow 130) into the project optimization and tradeoff engine 150. In an embodiment, the project impacts are the resource and capacity demands for a project as derived from the project scope. Each element of the project scope is evaluated to determine the capacity and resource demands on various business organizations and information technology systems. In an embodiment, the capacity and resource demands are estimated using an estimation model built that uses cost drivers established from past empirical data. The estimation model provides the capacity and resource demands broken down by roles, skills and competencies required to implement the scope elements. In an embodiment, the estimated Impacts [C] comprises a two dimensional matrix of project impacts in terms of capacity and resource demands, where C[i,j] is the project P[i]'s demand on capacity or resource R[j]. Moreover, in FIG. 1, in step 114, the project optimization and tradeoff engine 150 determines any project dependencies among the one or more projects inputted into the system 160. The project dependencies are identified during the project formation process and as the project scope is elaborated. The dependencies can be at the project level, such that, a project cannot be undertaken unless the project that this project depends on is also undertaken. This type of dependency is considered a “hard” dependency and forces a all-or-none constraint, that is, either all the dependent projects are included in the candidate portfolio or none are included. The dependencies can also be at the scope element level, such that, a scope element in a given project can only be delivered if the project that it depends on is also undertaken. This is considered a “soft” dependency and is modeled as a fractional dependency, that is, the fraction of business value of the candidate project that will not be delivered if the project that the candidate project depends on is not included in the candidate portfolio. In an embodiment, the project dependencies [D] comprises a two dimensional binary value matrix of project dependencies, where D[i,j]=0 when projects P[i] and P[j] are independent and where D[i,j]=1 when projects P[i] and P[j] are dependent. Further, the project optimization and tradeoff engine 150 estimates a business value in step 116. In an embodiment, the estimated business value [BV] comprises a two dimensional matrix of business values, where BV[i,i] represents the intrinsic business value of project P[i] and BV[i,j] represents the additional business value accrued to project P[i] when project P[j] is also present in the portfolio. In addition, the project optimization and tradeoff engine 150, part of the project portfolio management system 160, estimates or identifies in step 118 risks for the formulated candidate projects inputted that are under consideration. In an embodiment, the risk [R] comprises a vector of risks, where R[i] is the risk associated with the project P[i]. In an embodiment, there are two kinds of risks that are considered, one is a business risk BR[i], which is a risk of not achieving the business value in the marketplace, while the other is a technical risk TR[i], which represents the risk of not being able to deliver all the project capability in the product release. Accordingly, the overall risk R[i] estimated for the business is a product of the two risks: R[i]=BR[i]*TR[i]. A set of historical risk factors, based on prior product launches and previous project implementations, is used as the initial risk criteria. The initial risk criteria is augmented with additional risk factors that are identified and inputted into the system 160. An importance or weight factor is also assigned to each risk that signifies its relative importance and impact. The risk factors are scored by the project team and an aggregate risk score for the project is computed as the weighted sum of individual risk elements. This process is used for both the business and technical risks. The business risk and technical risk values, thus, computed are then combined into an aggregate risk value calculated as the complement of the product of the complements of business risk and technical risk. In an embodiment, the project portfolio management system 160 provides a user interface to allow a user to enter the scores and the logic needed to calculate the aggregate risk in step 118. The risk estimated in step 118 is examined (indicated by arrow 119) by the project optimization and tradeoff engine 150, which determines in step 120 whether or not the risks estimated for the projects are acceptable. If the project optimization and tradeoff engine 150 determines in step 120 that the risks identified are acceptable (indicated by the “yes” branch 121), then the project optimization and tradeoff engine 150 determines in step 122 the expected business value or risk adjusted business value, using the business value estimated in step 116 and the risk estimated in steps 118 through 120. In an embodiment, the expected business value or risk adjusted business value ABV[i] is calculated by adjusting the business value estimate provided by business personnel based on a success probability associated with the project, with success probability being computed as the complement of the aggregate risk calculated in step 118. In an embodiment, the expected business value is calculated by multiplying the estimated business value and the success probability for the project. as a product of the business value matrix multiplied by the Risk matrix, namely, [AVB]=[BV]*[R]. In another embodiment, a dynamic programming approach is used by the project optimization and tradeoff engine 150 to maximize the risk adjusted business value or expected business value, given the capacity/resource constraints. The expected business value is forwarded (indicated by arrow 123) to the project optimization and tradeoff engine 150. However, if the project portfolio management system 160 determines that the risks identified are not acceptable (indicated by the “no” branch 122), then the method returns to step 104, whereby a user is further directed to modify formulation of the project inputted into the system 160. The risk threshold is configurable based on the risk tolerance of the business either as a whole or by product or market sector. Accordingly, the project optimization and tradeoff engine 150 utilizes all the information provided to the system 160 to determine (in step 132) an optimal candidate project portfolio made up of the one or more projects that are inputted into the system 160 that produces an optimal expected business value. In one embodiment, the optimization engine progressively builds multi-dimensional capacity buckets of various sizes and then selects projects that will fit within the capacity bucket for maximizing the risk adjusted or expected business value. The portfolio optimization and tradeoff engine 150 maximizes the expected business value within the available capacity and resource constraints. The project optimization and tradeoff engine 150 considers capacity buckets of various sizes starting from smallest and then progressively building larger and larger capacity buckets up to the available capacity. As additional resources are added to the capacity buckets, additional projects are considered for inclusion by trading off projects already included to see if the expected business value could be increased. This engine builds optimal portfolios that will fit within the capacity buckets. Once the capacity buckets of sizes that equal the available resource-capacity supply are considered, the engine stops and the resulting portfolio is the optimal one. The engine maintains in a repository the sub-solutions of various size buckets and uses them to make project tradeoff decisions as new projects are evaluated, discussed further herein below. As shown in FIG. 1, the project optimization and tradeoff engine determines (indicated by double-sided arrow 128) that projects Pₚ, P_{q}, through pₜ are projects that should be included in an optimal candidate project portfolio. In an embodiment, the optimal project portfolio determined in step 132 (made up of projects pₚ, p_{q}, through pₜ) is stored (indicated by arrow 139) in a repository or database, such as, the Portfolio Database 180. The resources and capacity needed for these projects are reserved (indicated by arrow 133) in a repository or database, such as, the Enterprise Resource Database 170. Additionally, the project optimization and tradeoff engine 150 identifies in step 134 whether any inputted projects are determined to be suboptimal projects when additional new projects are inputted into the system 160 or when any change requests for the projects are submitted into the system 160. If the project optimization and tradeoff engine 150 identifies suboptimal projects, then in step 136, the project optimization and tradeoff engine 150 deselects suboptimal projects identified. In particular, as a new or additional project arrives, the engine attempts to fit the new project into the portfolio by removing current project(s) in the portfolio and by including the new project. If the business value is increased, the new project is included in the portfolio. This process is repeated for each new project. As shown in FIG. 1, the project optimization and tradeoff engine 150 identifies (indicated by arrow 129) that projects pᵤ, pᵥ, through p_{z} are suboptimal projects, then the project optimization and tradeoff engine 150 deselects the suboptimal projects identified in step 136 and stores (indicated by arrow 137) the suboptimal projects identified in a database, such as, the Enterprise Resource Database 170. Further, in step 138, the project optimization and tradeoff engine 150 identifies tradeoff candidates to be identified as tradeoff projects when additional new projects are inputted into the system 160 or when any change requests for the projects are submitted into the system 160. For instance, the project optimization and tradeoff engine 150 identifies (indicated by arrow 124) that projects pᵢ, pⱼ through pₙ are tradeoff candidates projects and in step 140 the project optimization and tradeoff engine 150 trades projects as necessary and stores (indicated by arrow 139) the tradeoff projects in a repository or database, such as, the Portfolio Database 180. The resources and capacity needed for these projects are released (indicated by arrow 141) in a repository or database, such as, the Enterprise Resource Database 170. Similarly, the projects traded off in step 140 are stored in the project optimization and tradeoff engine 150 trades any tradeoff projects that are identified as projects to be traded. Further, the project optimization and tradeoff engine 150 stores (indicated by double-sided arrow 139) any optimal project portfolios determined to optimize the expected business value of a business in an internal repository or database, such as, a portfolio database 180. Further, the project optimization and tradeoff engine 150 stores (indicated by arrow 133) any optimal project portfolios determined in a repository or database external to the project optimization and tradeoff engine 150, but within the project portfolio management system 160, such as, the Portfolio Database 180. The resources and capacity needed for these projects are reserved (indicated by arrow 133) in a repository or database, such as, the enterprise resource database 170. For instance, in an embodiment, optimal portfolios P₁ (reference numeral 143), P₂ (reference numeral 144), P₃ (reference numeral 145), through Pₙ (reference numeral 146) are stored in the portfolio database 180. As such, the repository or portfolio database can store one or more project portfolios, such as P₁, P₂, P₃, and P₄ (reference numerals 143, 144, 145 and 146, respectively), where each project portfolio can contain a different combination of projects that generate an optimized expected business value. As discussed herein above, the project optimization and tradeoff engine 150 utilizes all of the input data provided by the project portfolio management system 160 as well as by trading projects and deselecting any suboptimal projects, such that, the expected business value for the project portfolio that is determined is optimized.

In another embodiment, the invention provides a system for determining an optimal expected business value as a function of optimal project selections and project tradeoffs. The system includes a user interface configured to receive input of one or more candidate projects for a business, a processor configured to execute processing functions and to coordinate a plurality of activities and events for determining an optimal expected business value for the one or more candidate projects inputted for the business, a memory module having installed thereon a tool configured to determine an optimal candidate project portfolio that provides an optimal expected business value for the business. The tool further includes a resource and capacity module configured to identify any resource demands, any resource constraints, any capacity demands and any capacity constraints for the one or more candidate projects inputted, a risk assessment module configured to assess any risks associated with the one or more candidate projects inputted, a business valuation module configured to ascertain an estimated business value and an expected business value for the one or more candidate projects inputted, the expected business value including any risks assessed for the one or more candidate projects inputted, a portfolio module configured to construct an optimal candidate project portfolio using the one or more candidate projects inputted for the business based on any resource demands identified, any resource constraints identified, any capacity demands identified, any capacity constraints identified and any risks associated with the one or more candidate projects inputted, a tradeoff module configured to identify candidate projects to tradeoff when new candidate projects arise and when change requests for the one or more candidate projects inputted emerge for determining the optimal candidate project portfolio and a communications module configured to interconnect each of the user interface, the processor, the memory module and the tool for enabling data exchange. In an embodiment, the tool further includes an impact module configured to evaluate impact of any resource demands identified, any resource constraints identified, any capacity demands identified, any capacity constraints identified and a dependencies module configured to estimate dependencies between the one or more candidate projects inputted. The system further includes a storage module configured to store a respective optimal candidate project portfolio constructed and a respective expected business value computed for the respective optimal candidate project portfolio in a repository and a retrieval module configured to retrieve a respective optimal candidate project portfolio constructed and a respective expected business value computed for the respective optimal candidate project portfolio in the repository. The tool is further configured to construct a first candidate project portfolio that includes the one or more candidate projects for the business and is configured to allow combination changes to the one or more candidate projects in the first candidate project portfolio constructed in order to determine a respective expected business value for the first candidate project portfolio for the business. In an embodiment, the tool is further configured to add a candidate project to the one or more candidate projects to create a second candidate project portfolio, to establish resource constraints, capacity constraints and risks for the second candidate project portfolio, to ascertain a respective expected business value for the second candidate project portfolio and to compute a probability of achieving the business utilizing the second candidate project portfolio, wherein the respective expected business value for the second candidate project portfolio is optimized. In an embodiment, the tool is further configured to exclude a candidate project of the one or more candidate projects to create a different candidate project portfolio, to establish resource constraints, capacity constraints and risks for the different candidate project portfolio, to ascertain a respective expected business value for the different candidate project portfolio and to compute a probability of achieving the business utilizing the different candidate project portfolio, wherein the respective expected business value for the different candidate project portfolio is optimized.

Turning to FIG. 2, FIG. 2 is a schematic block system diagram illustrating one embodiment of a project optimization and tradeoff system 200 comprising a computing or computer system 202, such as, a standalone or personal computer or a server that has deployed thereon or is coupled to a system that has deployed thereon a portfolio management tool or manager 212 for managing portfolios, for instance, the Rational Portfolio Manager (RPM) tool or software 212, which is commercially available from International Business Machines Corporation (IBM). It is understood that any other commercially available portfolio management tools or software may be used to practice this invention. Further, in an embodiment of the invention, the portfolio management tool or manager 212 utilizes the project optimization and tradeoff engine 220 for determining an optimal candidate project portfolio by analyzing one or more candidate projects and selecting optimal projects to maintain and trading off suboptimal projects, such that, the optimal candidate project portfolio determined can optimize the expected business value for the business. Although the invention is discussed herein below in terms of a server, it is understood that the invention can be practiced on a personal computer running a portfolio manager 212.

As shown in FIG. 2, the server or system 200 comprises a central processing unit (CPU) 204, a local storage device 202, a user interface 206, a network interface 208 and a memory 210. The CPU 204 is configured generally to execute operations within the system/server 200, such as, the optimization and tradeoff engine or program tool or code 220 that is utilized by the portfolio manager program 212. The user interface 206, in an embodiment, is configured to allow a user to interact with the system 200, including allowing input of data and commands and communicating output data to the user. The network interface 206 is configured, in one embodiment, to facilitate network communications of the system 200 over a communications channel of a network. In one embodiment, as shown in FIG. 2, the optimization and tradeoff engine or program tool or code 220 which, in an embodiment, runs on the portfolio manager server or system 200, comprises a logic unit that contains a plurality of modules configured to functionally execute the necessary steps of determining an optimal project portfolio that optimizes the expected business value for a business. In particular, the optimization and tradeoff engine program tool or code 220 comprises an intake module 222, a business value estimation module 224, a resource and capacity module 226, an impact module 228, a project dependencies module 230, a risk assessment module 232, a project portfolio module 234, a project tradeoff module 236, a suboptimal projects module 2387, a storage module 240, a retrieval module 242 and a communications module 244.

Referring to FIG. 2, the intake module 222 of the project optimization and tradeoff engine 220 is configured to receive input for the one or more candidate projects being considered. The business value estimation or calculation module 224 is configured to estimate a business value for each of the one or more candidate projects under consideration. Further, the business value estimation module 224 is configured to determine an expected business value using the risks analyzed by the risk assessment module 232, described herein below. The resource and capacity module 226 is configured to establish and/or identify resource demands, resource consumption, resource constraints, capacity demands, capacity constraints, capacity targets for the one or more candidate projects under consideration. The impact module 228 is configured to evaluate and analyze the impact of the resource demands, resource consumption, resource constraints, capacity demands, capacity constraints, capacity targets for the one or more candidate projects under consideration. The project dependencies module 230 is configured to analyze and/or establish any project dependencies between the one or more candidate projects. The risk assessment module 232 is configured to analyze and/or evaluate any risks associated with the one or more candidate projects under consideration. The project portfolio module 234 is configured to determine an optimal project portfolio made up of the one or more candidate projects based on the evaluations carried out by the business value estimation module 224, the resource and capacity module 226, the impact module 228, the project dependencies module 236 and the risk assessment module 232. Further, the project tradeoff module 236 is configured to evaluate the one or more projects in a project portfolio when new candidate projects arise or are generated and/or when change requests are made or emerge for the one or more candidate projects chosen in an optimal project portfolio. In an embodiment, the project tradeoff module 236 is configured to identify or establish suitable projects to tradeoff, such that, the estimated or calculated business value for a given business can be optimized. In an embodiment, the project tradeoff module 236 utilizes the information or evaluations carried out by the business value estimation module 224, the resource and capacity module 226, the impact module 228, the project dependencies module 236 and the risk assessment module 232. Further, the suboptimal projects module 238 is configured to identify any suboptimal projects when new candidate projects arise or are generated and/or when change requests are made or emerge for the one or more candidate projects chosen in an optimal project portfolio. In an embodiment, the suboptimal projects module 238 utilizes the evaluations carried out by the business value estimation module 224, the resource and capacity module 226, the impact module 228, the project dependencies module 236 and the risk assessment module 232. Moreover, the project portfolio module 234 utilizes the evaluations carried out by the project tradeoff module 236 and the suboptimal projects module 238 in order to determine an optimal project portfolio that can optimize the expected business value for a business. In an embodiment, the storage module 240 is configured to store in a repository or database, such as, storage 202, the data inputted and generated for the one or more projects 214, including respective portfolios 216 created and their respective business value calculations and data/information pertaining to resource demands, resource consumption, resource constraints, capacity demands, capacity constraints, capacity targets and/or project dependencies for the one or more candidate projects. Further, the retrieval module 242 is configured to retrieve from a repository or database, such as, storage 202, the data inputted and generated for the one or more projects 214, including respective portfolios 216 created and their respective business value calculations and data/information pertaining to resource demands, resource consumption, resource constraints, capacity demands, capacity constraints, capacity targets and/or project dependencies for the one or more candidate projects. In addition, the communications module 236 is configured to permit communication between the various modules of the optimization and tradeoff engine or program tool or code 220 and the portfolio manager 212 and other systems, such as, the storage 202.

Referring now to FIG. 3, there is illustrated a computer system 300 that includes a computer infrastructure 302 having a computer program product for determining an optimal expected business value, in accordance with an embodiment of the present invention. The computer program product comprises a computer readable or computer-usable medium, which provides program code, namely, the optimization and tradeoff engine or program tool 316, for use by or in connection with a project portfolio manager or program 314, which in an embodiment is coupled to the memory 312 of system 304. The optimization and tradeoff engine program tool or program 316 can be loaded into the system 304 from a computer readable media 336, such as, a magnetic tape or disk, optical media, DVD, memory stick, semiconductor memory, etc. or downloaded from the Internet via a network adapter or card, such as, a TCP/IP adapter card 338. As depicted in FIG. 3, system 300 includes a computer infrastructure 302, namely, a portfolio management infrastructure 302, which is intended to represent any type of computer architecture that is maintained in a secure environment (i.e., for which access control is enforced). As shown, infrastructure 302 includes a computer system 304, which in an embodiment, represents a server 304, in particular, an portfolio management server or the like that includes an portfolio manager or portfolio management program 314, such as, the Rational Portfolio Manager (RPM) mentioned herein above. In addition, the system 304 includes the optimization and tradeoff engine or program tool 316, running on the system 304, which determines an optimal project portfolio made up of the one or more candidate projects based on the evaluations carried out by the business value estimation module 224, the resource and capacity module 226, the impact module 228, the project dependencies module 236, the risk assessment module 232, the project tradeoff module 236 and the suboptimal projects module 238, as discussed hereinabove with respect to FIG. 2. It should be understood, however, that although not shown, other hardware and software components (e.g., additional computer systems, routers, firewalls, etc.) could be included in infrastructure 302.

In general, user 1 (reference numeral 330) through user N (reference numeral 332) can access the computer infrastructure 302 for running the optimization and tradeoff engine program tool or code 316 for determining an optimal project portfolio that can achieve an optimal expected business value for a business. As mentioned herein above, the portfolio manager 314 utilizes the optimization and tradeoff engine 316 for determining an optimal project portfolio that can achieve an optimal expected business value for a business, as explained herein above with respect to FIG. 2. As shown in FIG. 3, the portfolio management system 304 within infrastructure 302 is configured to communicate with various other systems and/or servers, for instance, an administrator server or computer 334 that is used by an administrator of the infrastructure 302. In any event, communication with infrastructure 302 could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, the parties could utilize an Internet service provider to establish connectivity to infrastructure 302. It should be understood that under the present invention, infrastructure 302 could be owned and/or operated by a third party, such as, a service provider 340, or by an independent entity. Regardless, use of infrastructure 302 and the teachings described herein could be offered to the parties (users 1 through N) on a subscription or fee-basis. In either scenario, an administrator, for instance, at an administrator server 334 could support and configure infrastructure 302, for supporting and/or configuring the infrastructure 302, such as, upgrading the optimization and tradeoff engine 316 deployed on the portfolio management system 304.

The portfolio management system 304 (for instance, a server) is shown to comprise a CPU (hereinafter “processing unit 306”), a memory 312, a bus 310, and input/output (I/O) interfaces 308. Further, the system 304 is shown in communication with external I/O devices/resources 324. In general, processing unit 306 executes computer program code, such as, the portfolio manager program 314 and the optimization and tradeoff engine 316. While executing the optimization and tradeoff engine computer program code 316, the processing unit 306 can read and/or write data, to/from memory 312, storage system 342, and/or I/O interfaces 308. For instance, in one embodiment, the optimization and tradeoff engine 316 stores project data 326 associated with the one or more candidate projects under consideration in storage 342. Further, in an embodiment, the optimization and tradeoff engine 316 stores any project portfolio(s) that are created in storage 342. Alternatively, the project data 326 and the portfolio(s) 328 may be stored in a separate storage external to the infrastructure 302. Bus 310 provides a communication link between each of the components in computer system 300, such that, information can be communicated within the infrastructure 302. External devices 324 can include any devices (e.g., keyboard, pointing device, display, etc.) that enable a user to interact with computer system 300 and/or any devices (e.g., network card, modem, etc.) that enable system 304 to communicate with one or more other computing devices.

Computer infrastructure 302 is only illustrative of various types of computer infrastructures for implementing the invention. For example, in an embodiment shown, computer infrastructure 302 comprises two or more computing devices (e.g., a server cluster) that communicate over a network to perform the various process steps of the invention. Moreover, computer system 300 is only representative of various possible computer systems that can include numerous combinations of hardware. To this extent, in other embodiments, computer system 300 can include any specific purpose computing article of manufacture including hardware and/or computer program code for performing specific functions, any computing article of manufacture that includes a combination of specific purpose and general purpose hardware/software, or the like. In each case, the program code and hardware can be created using standard programming and engineering techniques, respectively. Moreover, processing unit 306 may comprise a single processing unit, or be distributed across one or more processing units in one or more locations, e.g., on a client and server. Similarly, memory 312 and/or storage system 342 can include any combination of various types of data storage and/or transmission media that reside at one or more physical locations. Further, I/O interfaces 308 can include any system for exchanging information with one or more external devices 324. Still further, it is understood that one or more additional components (e.g., system software, math co-processing unit, etc.) not shown in FIG. 3 can be included in computer system 300. However, if computer system 300 includes a handheld device or the like, it is understood that one or more external devices 324 (e.g., a display) could be contained within computer system 304, and not externally as shown.

Storage system 342 can be any type of system (e.g., a database) capable of providing storage for information, such as, the project data 326 and/or project portfolio(s) 328 under the present invention. To this extent, storage system 342 could include one or more storage devices, such as a magnetic disk drive or an optical disk drive. In another embodiment, storage system 342 includes data distributed across, for example, a local area network (LAN), wide area network (WAN) or a storage area network (SAN) (not shown). Although not shown, additional components, such as cache memory, communication systems, system software, etc., may be incorporated into computer system 300.

In yet another embodiment, the invention provides a process for deploying computing infrastructure comprising integrating computer-readable code into a computing system, wherein the code in combination with the computing system is capable of performing a process for determining an optimal expected business value for a business. The process comprises inputting one or more candidate projects for a business, comprising any resource demands, any resource constraints, any capacity demands, any capacity constraints, any risks and any project dependencies associated with the one or more candidate projects inputted, ascertaining an estimated business value and an expected business value based on a probability of achieving the business given any resource demands, any resource constraints, any capacity demands, any capacity constraints, any risks and any project dependencies associated with the one or more candidate projects inputted, determining an optimal candidate project portfolio that can be utilized under any resource demands, any resource constraints, any capacity demands, any capacity constraints and can provide an optimal expected business value for the business and identifying optimal projects to tradeoff when new candidate projects arise and when change requests for the one or more candidate projects inputted emerge for determining the optimal candidate project portfolio for the business. The process further comprises identifying suboptimal projects of the one or more candidate projects in the optimal candidate project portfolio to tradeoff either when a new candidate project is inputted or when a change request arrives, deselecting any of the suboptimal projects identified in the optimal candidate project portfolio, identifying tradeoff candidates to tradeoff for increasing the expected business value estimated and trading any of the tradeoff candidates identified as necessary. The process further comprises constructing a first candidate project portfolio comprised of the one or more candidate projects for the business, changing combinations of the one or more candidate projects in the first candidate project portfolio constructed and determining a respective optimal expected business value for the first candidate project portfolio for the business. In an embodiment, the changing step further comprises adding a candidate project to the one or more candidate projects in the first candidate project portfolio constructed to create a second candidate project portfolio, establishing resource constraints, capacity constraints and risks for the second candidate project portfolio, ascertaining a respective expected business value for the second candidate project portfolio and computing a probability of achieving the business utilizing the second candidate project portfolio, wherein the respective expected business value for the second candidate project portfolio is optimized. In an embodiment, the changing step comprises excluding a candidate project of the one or more candidate projects in a candidate project portfolio constructed to create a different candidate project portfolio, establishing resource constraints, capacity constraints and risks for the different candidate project portfolio, ascertaining a respective expected business value for the different candidate project portfolio and ascertaining a respective expected business value for the different candidate project portfolio based on a probability of achieving the business utilizing the different candidate project portfolio and based on the risks established, wherein the respective expected business value for the different candidate project portfolio is optimized.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for determining an optimal expected business value, said method comprising the steps of:
inputting, into a tool, one or more candidate projects for a business;
assessing impacts of any resource demands, any resource constraints, any capacity demands, any capacity constraints established, including assessing any project dependencies, business value, and any risks associated with said one or more candidate projects inputted;
estimating an expected business value for said one or more candidate projects inputted based on said business value assessed and said any risks assessed for said business, said expected business value including a probability of achieving said business; and
determining, using said tool, an optimal candidate project portfolio using results of said assessing step that can be utilized under said any resource demands, said resource constraints, said any capacity demands, said any capacity constraints established, said any project dependencies and said any risks assessed and based on said expected business value estimated for said business, wherein said optimal candidate project portfolio provides an optimal expected business value for said business.

2. The method according to claim 1, further comprising the steps of:
identifying suboptimal projects of said one or more candidate projects in said optimal candidate project portfolio to tradeoff either when a new candidate project is inputted or when a change request arrives;
deselecting any of said suboptimal projects identified in said optimal candidate project portfolio;
identifying tradeoff candidates to tradeoff for increasing said expected business value estimated; and
trading any of said tradeoff candidates identified as necessary.

3. The method according to claim 2, wherein said inputting step further comprises the step of:
providing said tool for inputting said one or more candidate projects for said business, wherein said tool comprises a portfolio optimization-tradeoff engine.

4. The method according to claim 3, wherein said determining step further comprises the step of:
selecting projects from said one or more candidate projects for said optimal candidate project portfolio that can be utilized under said any resource demands, said resource constraints, said any capacity demands, said any capacity constraints established, said any project dependencies and said any risks assessed, wherein a probability of achieving said optimal expected business value for said business is optimized.

5. The method according to claim 4, wherein said determining step further comprises the steps of:
constructing a first candidate project portfolio comprised of said one or more candidate projects inputted for said business;
changing combinations of said one or more candidate projects in said first candidate project portfolio constructed; and
determining a respective expected business value for said first candidate project portfolio for said business.

6. The method according to claim 5, wherein said changing step further comprises the steps of:
adding a candidate project to said one or more candidate projects in said first candidate project portfolio constructed to create a second candidate project portfolio;
assessing impacts of respective resource demands, respective resource constraints, respective capacity demands, respective capacity constraints, and assessing respective project dependencies, respective business values and respective risks for said second candidate project portfolio; and
ascertaining a respective expected business value for said second candidate project portfolio based on said respective business values assessed and based on said respective risks assessed for said second candidate project portfolio, including a respective probability of achieving said business utilizing said second candidate project portfolio, wherein said respective expected business value for said second candidate project portfolio is optimized.

7. The method according to claim 6, wherein said changing step further comprises the steps of:
excluding a candidate project of said one or more candidate projects in a candidate project portfolio constructed to create a different candidate project portfolio;
assessing impacts of different resource demands, different resource constraints, different capacity demands, different capacity constraints, and assessing different project dependencies, respective business values and respective risks for said second candidate project portfolio; and
ascertaining a respective expected business value for said different candidate project portfolio based on said different business values assessed and based on said different risks assessed for said different candidate project portfolio, including a respective probability of achieving said business utilizing said different candidate project portfolio, wherein said respective expected business value for said different candidate project portfolio is optimized.

8. The method according to claim 7, further comprising the step of:
repeating changing combinations of a respective optimal candidate project portfolio determined for said business to achieve a respective optimal expected business value for said business.

9. A system for determining an optimal expected business value, comprising:
a user interface configured to receive input of one or more candidate projects for a business;
a processor configured to execute processing functions and to coordinate a plurality of activities and events for determining an optimal expected business value for said one or more candidate projects inputted for said business;
a memory module having installed thereon a tool configured to determine an optimal candidate project portfolio that provides an optimal expected business value for said business, said tool further comprising:
a resource and capacity module configured to identify any resource demands, any resource constraints, any capacity demands and any capacity constraints for said one or more candidate projects inputted;
a risk assessment module configured to assess any risks associated with said one or more candidate projects inputted;
a business valuation module configured to ascertain an estimated business value and an expected business value for said one or more candidate projects inputted, said expected business value including said any risks assessed for said one or more candidate projects inputted;
a portfolio module configured to construct an optimal candidate project portfolio using said one or more candidate projects inputted for said business based on said any resource demands identified, said any resource constraints identified, said any capacity demands identified, said any capacity constraints identified and said any risks associated with said one or more candidate projects inputted;
a tradeoff module configured to identify candidate projects to tradeoff when new candidate projects arise and when change requests for said one or more candidate projects inputted emerge for determining said optimal candidate project portfolio; and
a communications module configured to interconnect each of said user interface, said processor, said memory module and said tool for enabling data exchange.

10. The system according to claim 9, wherein said tool further comprises:
an impact module configured to evaluate impact of said any resource demands identified, said any resource constraints identified, said any capacity demands identified, said any capacity constraints identified; and
a dependencies module configured to estimate dependencies between said one or more candidate projects inputted.

11. The system according to claim 10, further comprising:
a storage module configured to store a respective optimal candidate project portfolio constructed and a respective expected business value computed for said respective optimal candidate project portfolio in a repository; and
a retrieval module configured to retrieve a respective optimal candidate project portfolio constructed and a respective expected business value computed for said respective optimal candidate project portfolio in said repository.

12. The system according to claim 11, wherein said tool is further configured to construct a first candidate project portfolio comprised of said one or more candidate projects for said business and is configured to allow combination changes to said one or more candidate projects in said first candidate project portfolio constructed in order to determine a respective expected business value for said first candidate project portfolio for said business.

13. The system according to claim 12, wherein said tool is further configured to add a candidate project to said one or more candidate projects to create a second candidate project portfolio, to establish resource constraints, capacity constraints and risks for said second candidate project portfolio, to ascertain a respective expected business value for said second candidate project portfolio and to compute a probability of achieving said business utilizing said second candidate project portfolio, wherein said respective expected business value for said second candidate project portfolio is optimized.

14. The system according to claim 13, wherein said tool is further configured to exclude a candidate project of said one or more candidate projects to create a different candidate project portfolio, to establish resource constraints, capacity constraints and risks for said different candidate project portfolio, to ascertain a respective expected business value for said different candidate project portfolio and to compute a probability of achieving said business utilizing said different candidate project portfolio, wherein said respective expected business value for said different candidate project portfolio is optimized.

15. A computer program product for determining an optimal expected business value, said computer program product comprising:
a computer readable medium;
first program instructions to input one or more candidate projects for a business, said first program instructions including instructions to input any resource demands, any resource constraints, any capacity demands, any capacity constraints, any project dependencies and any risks associated with said one or more candidate projects;
second program instructions to ascertain an estimated business value for said one or more candidate projects inputted, said second program instructions including instructions to compute an expected business value using said estimated business value ascertained, said expected business value being based on a probability of achieving said business given said resource demands, said any resource constraints, said any capacity demands, said any capacity constraints, said any risks and said any project dependencies associated with said one or more candidate projects inputted;
third program instructions to determine an optimal candidate project portfolio that optimizes said expected business value computed for said business that can be utilized under said any resource demands, said any resource constraints, said any capacity demands, said any capacity constraints, said any risks and said any project dependencies, and wherein said first, second and third program instructions are recorded on said computer readable medium.

16. The computer program product according to claim 15, further comprising:
fourth program instructions to identify optimal projects to tradeoff when new candidate projects arise and when change requests for said one or more candidate projects inputted emerge in order to determine said optimal candidate project portfolio, and wherein said fourth program instructions are recorded on said computer readable medium.

17. The computer program product according to claim 16, wherein said first program instructions include instructions to construct a first candidate project portfolio comprised of said one or more candidate projects for said business, to change combinations of said one or more candidate projects in said first candidate project portfolio constructed, and to determine a respective expected business value for said first candidate project portfolio constructed for said business.

18. The computer program product according to claim 17, wherein said second program instructions include instructions to add a candidate project to said one or more candidate projects to create a second candidate project portfolio, to establish any other resource demands, any other resource constraints, any other capacity demands, any other capacity constraints, any other risks and any other dependencies for said second candidate project portfolio, to ascertain a respective expected business value for said second candidate project portfolio using a probability of achieving said business utilizing said second candidate project portfolio, wherein said respective expected business value for said second candidate project portfolio is optimized.

19. The computer program product according to claim 18, wherein said third program instructions include instructions to exclude a candidate project of said one or more candidate projects to create a different candidate project portfolio, to establish respective resource demands, respective resource constraints, respective capacity demands, respective capacity constraints, respective risks and respective dependencies for said different candidate project portfolio, to ascertain a respective expected business value for said different candidate project portfolio using a probability of achieving said business utilizing said different candidate project portfolio, wherein said respective expected business value for said different candidate project portfolio is optimized.

20. The computer program product according to claim 19, wherein said fourth program instructions include instructions to identify suboptimal projects of said one or more candidate projects in said optimal candidate project portfolio to tradeoff either when said new candidate project is inputted or when said change request arrives, said fourth program instructions including instructions to deselect any of said suboptimal projects identified, identifying tradeoff candidates to tradeoff for increasing said expected business value estimated, and trading any of said tradeoff candidates identified as necessary.

21. A process for deploying computing infrastructure comprising integrating computer-readable code into a computing system, wherein said code in combination with said computing system is capable of performing a process for determining an optimal expected business value for a business, said process comprising:
inputting one or more candidate projects for a business, including any resource demands, any resource constraints, any capacity demands, any capacity constraints, any risks and any project dependencies associated with said one or more candidate projects inputted;
ascertaining an estimated business value and an expected business value based on a probability of achieving said business given said any resource demands, said any resource constraints, said any capacity demands, said any capacity constraints, said any risks and said any project dependencies associated with said one or more candidate projects inputted;
determining an optimal candidate project portfolio that can be utilized under said any resource demands, said any resource constraints, said any capacity demands, said any capacity constraints and can provide an optimal expected business value for said business; and
identifying optimal projects to tradeoff when new candidate projects arise and when change requests for said one or more candidate projects inputted emerge for determining said optimal candidate project portfolio for said business.

22. The process according to claim 21, further comprising the steps of:
identifying suboptimal projects of said one or more candidate projects in said optimal candidate project portfolio to tradeoff either when a new candidate project is inputted or when a change request arrives;
deselecting any of said suboptimal projects identified in said optimal candidate project portfolio;
identifying tradeoff candidates to tradeoff for increasing said expected business value estimated; and
trading any of said tradeoff candidates identified as necessary.

23. The process according to claim 22, further comprising the steps of:
constructing a first candidate project portfolio comprised of said one or more candidate projects for said business;
changing combinations of said one or more candidate projects in said first candidate project portfolio constructed; and
determining a respective optimal expected business value for said first candidate project portfolio for said business.

24. The process according to claim 23, wherein said changing step further comprises the steps of:
adding a candidate project to said one or more candidate projects in said first candidate project portfolio constructed to create a second candidate project portfolio;
establishing resource constraints, capacity constraints and risks for said second candidate project portfolio;
ascertaining a respective expected business value for said second candidate project portfolio; and
computing a probability of achieving said business utilizing said second candidate project portfolio, wherein said respective expected business value for said second candidate project portfolio is optimized.

25. The process according to claim 24, wherein said changing step further comprises the steps of:
excluding a candidate project of said one or more candidate projects in a candidate project portfolio constructed to create a different candidate project portfolio;
establishing resource constraints, capacity constraints and risks for said different candidate project portfolio; and
ascertaining a respective expected business value for said different candidate project portfolio based on a probability of achieving said business utilizing said different candidate project portfolio and based on said risks established, wherein said respective expected business value for said different candidate project portfolio is optimized.
